(19) United States
(12) Patent Application Publication
(10) Pub. No.: US 2026/0295525 A1
(43) Pub. Date: Oct. 1, 2026

(54) HONEYCOMB STRUCTURE AND HONEYCOMB FILTER

(71) Applicant: NGK INSULATORS, LTD., Nagoya-shi (JP)

(72) Inventor: Yusuke TSUCHIYA, Kuwana-shi (JP)

(73) Assignee: NGK INSULATORS, LTD., Nagoya-shi (JP)

(21) Appl. No.: 19/576,177

(22) Filed: Mar. 24, 2026

(30) Foreign Application Priority Data
Mar. 31, 2025 (JP) 2025-059967

(51) Int. Cl. B01D 53/94; B01D 39/20; B01D 46/24; B01J 35/57

(52) U.S. Cl. CPC B01D 53/94; B01D 39/2068; B01D 46/2444; B01D 46/24491; B01D 46/24492; B01D 46/2498; B01J 35/57; B01D 2255/9155; B01D 2255/9202; B01D 2255/9205; B01D 2258/01; B01D 2279/30

(57) ABSTRACT

A honeycomb structure includes: a pillar shaped honeycomb substrate 10 having porous partition walls 12 that define a plurality of cells 11, each of the cells 11 extending from an inflow end face 14 to an outflow end face 15 of the honeycomb substrate 10 to form a flow path for a fluid; and a porous outer peripheral coating layer 13 disposed on an outer peripheral surface of the honeycomb substrate 10, wherein the honeycomb substrate 10 includes pores having a pore diameter that causes capillary action in the partition walls 12, and wherein, when an average pore diameter of the honeycomb substrate is B [μm], and an average pore diameter of the outer peripheral coating layer is A [μm], a relationship of B<A is satisfied.

### CROSS REFERENCE TO RELATED APPLICATIONS

This application claims the benefit of priority to Japanese Patent Applications No 2025-059967 filed on Mar. 31, 2025, with the Japanese Patent Office, the entire contents of which are incorporated herein by reference in its entirety.

### FIELD OF THE INVENTION

This invention relates to a honeycomb structure and a honeycomb filter.

### BACKGROUND OF THE INVENTION

Honeycomb structures and honeycomb filters using the same are known as devices for collecting particulate matter or purifying toxic gas components emitted from internal combustion engines such as automobiles. Honeycomb structures are produced by extruding a ceramic green body obtained by mixing raw material powder, a forming aid, a pore former raw material, and water with a special die, drying the formed body in a drying furnace, and firing it in a firing furnace. In recent years, with an increase in diameter of honeycomb structures and a reduction in thickness of cells, it has become difficult to obtain dimensional accuracy and mechanical strength required as products. As one method for improving dimensional accuracy and mechanical strength, it is generally performed to grind an outer periphery of a formed body and then apply an outer peripheral coating material to a surface thereof to produce an outer peripheral wall.

Japanese Patent Application Publication No. 2004-75523 (Patent Literature 1) describes a ceramic honeycomb structure obtained by removing a peripheral portion of a ceramic honeycomb structure having a number of flow passages partitioned by cell walls by processing, and then applying an outer peripheral coating material to an outer peripheral surface to form an outer peripheral wall.

In recent years, demands for weight reduction of honeycomb structures and honeycomb filters have also been increasing for improving fuel efficiency of automobiles, and increasing porosity of outer peripheral coating materials is also one proposal. When porosity of the outer peripheral coating material is increased, there is a problem that a large amount of catalyst adheres to the outer peripheral coating material during catalyst coating. In addition, by increasing porosity of the outer peripheral coating material, there is also a problem that the catalyst leaks out from the honeycomb structure during catalyst coating.

As one method for solving such a problem, for example, Japanese Patent Application Publication No. 2009-183835 (Patent Literature 2) proposes a method of cutting an outer peripheral surface of a joined body of honeycomb segments, then producing a catalyst supported body by supporting a catalyst on a surface of the obtained cut body, and disposing an outer peripheral coating layer on an outer peripheral surface of the catalyst supported body.

Further, Japanese Patent No. 5431158 (Patent Literature 3) describes a method for producing a catalyst support in which a magnetoplumbite-type composite oxide is generated by filling pores with an aqueous solution using a pore-filling method utilizing a capillary action occurring in pores of porous alumina, and then drying and firing it.

### CITATION LIST

### Patent Literatures

[Patent Literature 1] Japanese Patent Application Publication No. 2004-75523 A
[Patent Literature 2] Japanese Patent Application Publication No. 2009-183835 A
[Patent Literature 3] Japanese Patent No. 5431158 B

### SUMMARY OF THE INVENTION

Supporting of a catalyst on a honeycomb structure may be performed by dip coating or the like in which the honeycomb structure is immersed in a catalyst liquid and coated, but the catalyst also adheres to an outer peripheral coating layer during coating. Since the catalyst liquid used for supporting the catalyst contains precious metals such as platinum (Pt), it is desirable to minimize adhesion of the catalyst to an outer peripheral coating layer as much as possible, in order to reduce an amount of catalyst used.

However, the invention described in Patent Literature 1 only proposes a method of making a thermal expansion coefficient of the outer peripheral wall smaller than a radial thermal expansion coefficient of the cell wall, and does not describe catalyst supporting on ceramic honeycomb structures. The invention described in Patent Literature 2 is desirable in that adhesion of a catalyst to an outer peripheral coating layer can be suppressed, but there is also room for consideration regarding other methods than Patent Literature 2. The invention described in Patent Literature 3 also does not describe any finding regarding catalyst adhesion to honeycomb structures provided with an outer peripheral coating layer.

In view of the above problems, this invention provides a honeycomb structure and a honeycomb filter that can cause a catalyst to adhere selectively onto a honeycomb substrate while suppressing adhesion of the catalyst to an outer peripheral coating layer.

As a result of intensive studies to solve the above problems, the present inventor has focused on a balance between a pore diameter of a honeycomb substrate and a pore diameter of an outer peripheral coating layer provided on an outer peripheral surface thereof, and have completed this invention. That is, this invention is exemplified as follows:

### [Aspect 1]

In an embodiment, this invention is a honeycomb structure including: a pillar shaped honeycomb substrate having porous partition walls that define a plurality of cells, each of the cells extending from an inflow end face to an outflow end face of the honeycomb substrate to form a flow path for a fluid; and a porous outer peripheral coating layer disposed on an outer peripheral surface of the honeycomb substrate, wherein the honeycomb substrate includes pores having a pore diameter that causes capillary action in the partition walls, and wherein, when an average pore diameter of the honeycomb substrate is B [μm], and an average pore diameter of the outer peripheral coating layer is A [μm], a relationship of B<A is satisfied.

### [Aspect 2]

In another embodiment, this invention is the honeycomb structure according to Aspect 1, wherein when an average porosity of the honeycomb substrate is P2 [%] and an average porosity of the outer peripheral coating layer is P1 [%], a relationship of A>B×(P1/P2)^{0.2} may be satisfied.

### [Aspect 3]

In yet another embodiment, this invention is the honeycomb structure according to Aspect 1 or 2, wherein when an average porosity of the outer peripheral coating layer is P1 [%], a relationship of A<670−⅙×P1² may be satisfied.

### [Aspect 4]

In yet another embodiment, this invention is the honeycomb structure according to any of Aspects 1 to 3, wherein the average pore diameter B of the honeycomb substrate may be 5 μm to 30 μm.

### [Aspect 5]

In yet another embodiment, this invention is the honeycomb structure according to any one of Aspects 1 to 4, wherein the average pore diameter A of the outer peripheral coating layer may be more than 5 μm and 500 μm or less.

### [Aspect 6]

In yet another embodiment, this invention is the honeycomb structure according to any of Aspects 1 to 5, wherein the average porosity P2 of the honeycomb substrate may be 20 to 70%.

### [Aspect 7]

In yet another embodiment, this invention is the honeycomb structure according to any of Aspects 1 to 6, wherein the average porosity P1 of the outer peripheral coating layer may be 30 to 75%.

### [Aspect 8]

In yet another embodiment, this invention is the honeycomb structure according to any of Aspects 1 to 7, wherein the average pore diameter B is 5 μm to 30 μm, an amount of catalyst supported on the partition walls of the honeycomb substrate is larger than an amount of catalyst supported on the outer peripheral coating layer, and the honeycomb structure is configured to support a catalyst on the honeycomb substrate and the outer peripheral coating layer using capillary action.

### [Aspect 9]

In yet another embodiment, this invention is the honeycomb structure according to any one of Aspects 1 to 8, wherein the honeycomb substrate includes a plurality of honeycomb substrates, and the plurality of honeycomb substrates are joined by a joining layer for joining the plurality of honeycomb substrates to each other, and the outer peripheral coating layer is provided so as to surround outer peripheral surfaces of the plurality of honeycomb substrates joined by the joining layer.

### [Aspect 10]

In yet another embodiment, this invention is a honeycomb filter including: a pillar shaped honeycomb substrate having porous partition walls that define a plurality of cells, each of the cells extending from an inflow end face to an outflow end face of the honeycomb substrate to form a flow path for a fluid; and a porous outer peripheral coating layer disposed on an outer peripheral surface of the honeycomb substrate, wherein the honeycomb substrate includes pores having a pore diameter that causes capillary action in the partition walls, a catalyst is supported on the partition walls, and when an average pore diameter of the honeycomb substrate is B [μm] and an average pore diameter of the outer peripheral coating layer is A [μm], a relationship of B<A is satisfied.

### [Aspect 11]

In yet another embodiment, this invention is a honeycomb filter according to Aspect 10, wherein the average pore diameter B is 5 μm to 30 μm, and an amount of catalyst supported on the partition walls of the honeycomb substrate is larger than an amount of catalyst supported on the outer peripheral coating layer.

### [Aspect 12]

In yet another embodiment, this invention is a honeycomb filter according to Aspect 10 or 11, wherein the amount of the catalyst supported is progressively reduced from the inflow end face to the outflow end face, or from the outflow end face to the inflow end face.

According to the present invention, it is possible to provide a honeycomb structure and a honeycomb filter that can cause a catalyst to adhere selectively onto a honeycomb substrate while suppressing adhesion of the catalyst to an outer peripheral coating layer.

### BRIEF DESCRIPTION OF THE DRAWINGS

FIG. 1 is a perspective view of a honeycomb structure according to an embodiment of this invention.

### DETAILED DESCRIPTION OF THE INVENTION

Hereinafter, embodiments of this invention will be described with reference to the drawings. It should be noted that the following embodiments exemplify devices and methods for embodying a technical idea of this invention, and the technical idea of this invention does not limit structures, arrangements, and the like of components to those described below.

### <Honeycomb Structure>

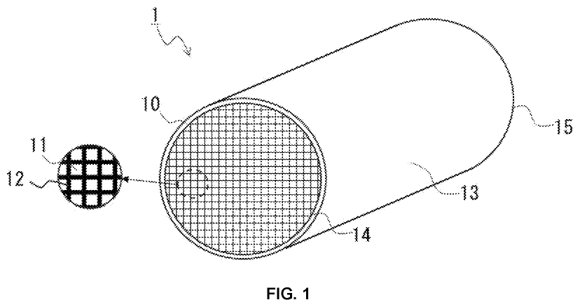

As shown in FIG. 1, a honeycomb structure 1 according to an embodiment of this invention includes: a pillar shaped honeycomb substrate 10 having porous partition walls 12 that define a plurality of cells 11, each of the cells 11 extending from an inflow end face 14 to an outflow end face 15 to form a flow path for a fluid; and a porous outer peripheral coating layer 13 disposed on an outer peripheral surface of the honeycomb substrate 10.

An outer shape of the honeycomb structure 1 is not particularly limited, and a cross section perpendicular to an extending direction of the cells 11 can be a pillar shape having a circular shape, an oval shape, or a polygonal shape (quadrangular, pentagonal, hexagonal, heptagonal, octagonal, and the like). FIG. 1 shows, as an example, the honeycomb structure 1 in which an outer shape is circular in a cross section perpendicular to an extending direction of the cells 11.

A diameter of end faces of the honeycomb structure 1 is not particularly limited, and can be appropriately set according to applications and required performance. Since manufacturing difficulty increases when a diameter of each end face of the honeycomb structure 1 is too large, the diameter of each end face is preferably 30 to 600 mm, and more preferably 50 to 500 mm. It should be noted that the diameter of each end face of the honeycomb structure 1 means a diameter when an outer shape is circular, and means a circle-equivalent diameter when the outer shape is other than circular. When end faces of the honeycomb structure 1 are quadrangular, a length of one side of the inflow end face 14 and the outflow end face 15 is preferably 35 to 500 mm, and more preferably 100 to 200 mm.

A material of the honeycomb substrate 10 is not particularly limited, and porous ceramics can be used. Examples of the ceramics include cordierite, mullite, zirconium phosphate, aluminum titanate, silicon carbide, a silicon-silicon carbide composite material (for example, Si-bonded SiC), a cordierite-silicon carbide composite material, zirconia, spinel, indialite, sapphirine, corundum, titania, and silicon nitride. These ceramics may contain one kind alone, or may contain two or more kinds simultaneously. Other materials of the honeycomb substrate 10 include porous sintered metals containing one or more alloy components selected from the group consisting of Fe, Cr, Mo, and Ni as a main component.

In one embodiment, the honeycomb substrate 10 is preferably formed of a material containing cordierite as a main component. When the honeycomb substrate 10 contains cordierite as a main component, it is preferable that the honeycomb substrate 10 contains 50% by mass or more, and preferably 60% by mass or more of cordierite.

In one embodiment, the honeycomb substrate 10 is preferably formed of a material containing a silicon carbide material or a silicon-silicon carbide composite material as a main component. Among porous ceramics, silicon-silicon carbide composite materials are suitable for filter applications because of their excellent heat resistance, thermal shock resistance, and oxidation resistance. The silicon-silicon carbide composite material contains silicon carbide particles as aggregate, and silicon as a binder that bonds the silicon carbide particles. It is preferable that this silicon-silicon carbide composite material has a plurality of silicon carbide particles bonded by the silicon so as to form pores between the silicon carbide particles.

It should be noted that, when a silicon carbide material or a silicon-silicon carbide composite material is contained as a main component, it is preferable that the silicon carbide material or the silicon-silicon carbide composite material contains 50% by mass or more based on the total mass, more preferably 60% by mass or more, and still more preferably 70% by mass or more. In addition, a blending ratio of silicon and silicon carbide in the honeycomb substrate 10, a type of firing aid, and a blending ratio thereof can be appropriately adjusted according to required dimensions and applications.

A shape of each cell 11 is not particularly limited, but in a cross section perpendicular to an extending direction of the cells 11, it may have any shape such as a polygon such as a triangle, a quadrangle, a pentagon, a hexagon, or an octagon, a circle, or an ellipse, or may be irregular. By providing the cells 11 having such a shape, it is possible to reduce the pressure loss when the air flows. FIG. 1 shows, as an example, the honeycomb structure 1 in which the shape of each cell 11 is quadrangular in a cross section perpendicular to an extending direction of the cells 11.

A density of the cells 11 (number of cells 11 per unit cross-sectional area) is not particularly limited, but it may preferably be in a range of 15 to 77 cells/cm² more preferably in a range of 20 to 62 cells/cm², and still more preferably in a range of 23 to 54 cells/cm². It should be noted that the density of the cells 11 is a value obtained by dividing a number of cells 11 possessed by the honeycomb structure 1 in a cross section perpendicular to an extending direction of the cells 11 by an area of the honeycomb structure 1 excluding the outer peripheral coating layer 13, and can be measured by microscopic observation using a microscope or the like.

A thickness of the partition walls 12 that define the cells 11 is not particularly limited, but from viewpoints of weight reduction requirement and pressure loss reduction, it is preferable that the thickness is reduced as much as possible. On the other hand, when the thickness of the partition walls 12 is excessively reduced, mechanical strength may be insufficient. For example, the thickness of the partition walls 12 is preferably 75 to 500 μm, more preferably 100 to 450 μm, and still more preferably 125 to 400 μm. It should be noted that the thickness of the partition walls 12 means a length in which a line segment crosses the partition wall 12 when centers of gravity of adjacent cells 11 are connected by the line segment in the cross section perpendicular to the extending direction of the cells 11, and can be measured by microscopic observation using a microscope or the like.

The outer peripheral coating layer 13 is formed, which has a predetermined thickness on an outer peripheral surface of the honeycomb substrate 10. This outer peripheral coating layer 13 can be formed by applying a slurry-like outer peripheral coating material containing a ceramic material to an outer peripheral surface of the honeycomb substrate 10. The outer peripheral coating layer 13 is formed after processing an outer peripheral surface of the honeycomb substrate 10. As a result, deformed cells 11 that may be formed in an outer peripheral portion during production of the honeycomb substrate 10 can be removed in advance before forming the outer peripheral coating layer 13, so that mechanical strength of the honeycomb structure 1 is improved. In addition, by forming the outer peripheral coating layer 13 on the outer peripheral surface after processing the outer peripheral surface of the honeycomb substrate 10 to desired dimensions, dimensional accuracy is also improved.

A material of the outer peripheral coating layer 13 is not particularly limited, but it is typically formed of a ceramic material. Examples of the material of the outer peripheral coating layer 13 includes cordierite, silicon carbide, or titanium oxide. The material of the outer peripheral coating layer 13 is preferably the same as a main component of a material making up the honeycomb substrate 10, because a difference in thermal expansion coefficient between the honeycomb substrate 10 and the outer peripheral coating layer 13 can be reduced. In addition to the above ceramic materials, the material of the outer peripheral coating layer 13 may also contain a binder, a dispersion medium, an additive, and the like.

A thickness of the outer peripheral coating layer 13 is not particularly limited, but by having the thickness of 0.1 to 3.0 mm, thermal shock resistance and the like can be improved. The thickness of the outer peripheral coating layer 13 is, for example, preferably 0.15 to 2.5 mm, and more preferably 0.2 to 2 mm. It should be noted that the thickness of the outer peripheral coating layer 13 means a length in a normal direction from a boundary between a partition wall 12 of an outermost cell 11 and the outer peripheral coating layer 13 to an outer peripheral surface of the honeycomb structure 1 in the cross section perpendicular to the extending direction of the cells 11. The thickness of the outer peripheral coating layer 13 is an average value when eight positions at every 45° in a circumferential direction on the end face of the honeycomb structure 1 are taken as measurement positions and each measurement position is measured by microscopic observation.

The capillary action is a phenomenon in which a liquid inside a capillary tube moves through the capillary tube without being given energy from the outside, and is mainly caused by surface tension. A rising height (h) of a liquid surface in the capillary action can generally be expressed by the following equation (1):

$$h = 2 T cos θ / ( ρ \cdot g \cdot r ) \qquad ( 1 )$$

in which T is a surface tension of the liquid, θ is a contact angle (angle between the liquid and solid contact surfaces), ρ is a density of the liquid, g is a acceleration of gravity, and r is a inner diameter (radius) of the capillary tube.

In this embodiment, the capillary action is used to support the catalyst on the honeycomb structure 1. That is, the honeycomb substrate 10 according to the present embodiment includes pores having a pore diameter that causes the capillary action in the partition walls 12, and when an average pore diameter of the honeycomb substrate 10 is B [μm] and an average pore diameter of the outer peripheral coating layer 13 is A [μm], a relationship of B<A is satisfied.

According to the honeycomb structure 1 according to the present embodiment, during catalyst supporting, a catalyst liquid containing a catalyst leaches from pores on a surface of the partition walls 12 of the honeycomb substrate 10 to the interior of the partition walls 12 by the capillary action. The average pore diameter A of the outer peripheral coating layer 13 is larger than the average pore diameter B of the honeycomb substrate 10. Therefore, as is understandable from the equation (1), the depth at which the catalyst liquid leaches from the surface to the interior by the capillary action is greater in the honeycomb substrate 10 than in the outer peripheral coating layer 13. According to the honeycomb structure 1 according to the present embodiment, a larger amount of the catalyst can be cause to adhere onto the honeycomb substrate 10 than the outer peripheral coating layer 13 of the honeycomb structure 1.

Although it is preferable that the pores that cause the capillary action formed in the partition walls 12 are formed throughout the entire honeycomb substrate 10 from a viewpoint of ease of production, the pores may be selectively formed only at a surface layer portions of the partition walls 12. When the pores are selectively formed only at the surface layer portions of the partition walls 12, an average pore diameter B of the honeycomb substrate 10 according to the present embodiment means an average pore diameter of pores at the portions where the pore diameters are formed. When the pores are formed throughout the entire honeycomb substrate 10, the average pore diameter B of the honeycomb substrate 10 means a pore diameter of the entire honeycomb substrate 10.

The catalyst supporting on the honeycomb structure 1 using the capillary action may be related not only to pore diameters of the honeycomb substrate 10 and the outer peripheral coating layer 13, but also to porosities thereof. Therefore, in the present embodiment, it is preferable to consider pore characteristics including average porosities in addition to average pore diameters A of the honeycomb substrate 10 and the outer peripheral coating layer 13. That is, the honeycomb substrate 10 according to the present embodiment preferably satisfies a relationship of the following equation (2) in addition to the relationship of B<A, when an average pore diameter of the honeycomb substrate 10 is B [μm], an average pore diameter of the outer peripheral coating layer 13 is A [μm], an average porosity of the honeycomb substrate 10 is P2 [%], and an average porosity of the outer peripheral coating layer 13 is P1 [%]:

$$A > B \times {( P 1 / P 2 )}^{0.2} \qquad ( 2 )$$

The average pore diameters A, B and average porosities P1, P2 of the honeycomb substrate 10 and the outer peripheral coating layer 13 have the relationship of the equation (2), whereby the catalyst can be caused to adhere selectively onto the honeycomb substrate 10 while suppressing adhesion of the catalyst to the outer peripheral coating layer 13, and also to suppress seepage of the catalyst from the outer peripheral coating layer 13 during catalyst supporting.

In catalyst supporting on the honeycomb structure 1 using the capillary action, it is preferable to take into account empirical matters including producing viewpoints such as: pores formed in the partition walls 12 of the honeycomb substrate 10 do not actually have a tubular shape as assumed in the equation (1); a viscosity of a catalyst liquid to be leached into pores of the partition walls 12 may affect a leaching depth of the catalyst liquid by the capillary action; or catalyst leakage occurs when a catalyst is actually supported on the honeycomb structure 1 using the capillary action. As a result of comprehensively considering these empirical matters, the honeycomb structure 1 according to an embodiment of this invention more preferably satisfies a relationship of the following relational equation (3) in addition to the relationship of B<A, when an average pore diameter of the outer peripheral coating layer 13 is A [μm], an average pore diameter of the honeycomb substrate 10 is B [μm], and an average porosity of the outer peripheral coating layer 13 is P1 [%].

$$A < 670 - 1 / 6 \times P {1}^{2} \qquad ( 3 )$$

The average pore A and the average porosity P1 of the outer peripheral coating layer 13 have the relationship of the equation (3), whereby it becomes possible to adhere a larger amount of catalyst into pores of the partition walls 12 of the honeycomb substrate 10 while suppressing leakage of the catalyst from the honeycomb structure 1 during catalyst coating and suppressing adhesion of the catalyst to the outer peripheral coating layer 13 and seepage, and to support a predetermined amount of catalyst on the honeycomb structure 1. It should be noted that the honeycomb structure 1 according to an embodiment of this invention more preferably satisfies the relationship of the equation (2) and/or the equation (3) in addition to the relationship of B<A.

The average pore diameters A and B and the average porosities P1 and P2 can be derived from images obtained by observation using a scanning electron microscope (SEM) (SEM images) as follows. First, the honeycomb structure 1 including the honeycomb substrate 10 and the outer peripheral coating layer 13 is cut so that a cross section perpendicular to the extending direction of the cells 11 serves as an observation surface, and resin filling and polishing of a cut surface are performed to obtain a sample for observation. A magnification of the SEM is set to 100 to 500 times, and SEM images of the honeycomb substrate 10 and the outer peripheral coating layer 13 are obtained by photographing the observation surface of the sample for observation. The SEM images can be analyzed with commercially available image analysis software. In image analysis, for example, threshold values are determined by discriminant analysis method from the luminance distribution of luminance data of pixels in the SEM images. Based on the determined threshold value, each pixel in the SEM image is binarized into a solid portion and a pore portion, and the area of the solid portion and the area of the pore portion are calculated. The ratio of the area of the pore area to the total area (total area of the solid and pore portions) is defined as the porosity (unit: %). The pore diameter is calculated using commonly available software that calculates a pore diameter by fitting an inscribed circle to the pore in the SEM image. Available software is not particularly limited, but it can be calculated using, for example, PoreSpy or the like available from open source of Python. The above measurements are repeated five times to derive the average pore diameters A and B and the average porosities P1 and P2.

When the average pore diameter A and the average porosity P1 of the outer peripheral coating layer 13 are excessively increased, catalyst retention force in pores by the capillary action is lost, and the catalyst may leak out. In particular, when increasing the average porosity P1 of the outer peripheral coating layer 13, an excessively large average pore diameter A may lead to a larger amount of catalyst leaking out. On the other hand, when the average pore diameter A and the average porosity P1 of the outer peripheral coating layer 13 are excessively reduced, the catalyst retention force in pores increases due to the capillary action, and a large amount of catalyst may adhere to the outer peripheral coating layer 13.

The average pore diameter A of the outer peripheral coating layer 13 is not particularly limited, but it is preferably more than 5 μm and 500 μm or less, more preferably 6 to 400 μm, and still more preferably 6.5 to 300 μm. In one embodiment, the average pore diameter A may be 6.5 to 60 μm, and in another embodiment, it may be 20 to 60 μm. In yet another embodiment, the average pore diameter A may be 100 to 450 μm, and in still another embodiment, it may be 110 to 300 μm. The average porosity P1 of the outer peripheral coating layer 13 is not particularly limited, but it is preferably 30 to 75%, more preferably 32 to 70%, and still more preferably 34 to 60%. In one embodiment, the average porosity P1 may be 30 to 60%, and in another embodiment, it may be 30 to 35%.

The average pore diameter B of the honeycomb substrate 10 is not particularly limited, but it is preferably 5 to 30 μm, more preferably 5 to 26 μm, and still more preferably 6 to 24 μm. In one embodiment, the average pore diameter B may be 9 to 18 μm, and in another embodiment, it may be 12 to 18 μm. The average porosity P2 of the honeycomb substrate 10 is not particularly limited, but it is preferably 20 to 70%, more preferably 30 to 67%, and still more preferably 35 to 65%. In one embodiment, the average porosity P2 may be 30 to 65%, and in another embodiment, it may be 40 to 55%.

In order for capillary action suitable for catalyst supporting to occur, although not particularly limited, it is preferable that the average pore diameter A of the outer peripheral coating layer 13 is larger than the average pore diameter B of the honeycomb substrate 10 by 2 to 420 μm, more preferably 5 to 300 μm, and still more preferably 10 to 150 μm.

According to the honeycomb structure 1 according to an embodiment of this invention, the porous honeycomb substrate 10 making up the honeycomb structure 1 has an average pore diameter A suitable for coating of the catalyst using the capillary action, and the average pore diameter A of the outer peripheral coating layer 13 is larger than the average pore diameter B of the honeycomb substrate 10. Therefore, according to the honeycomb structure 1 according to an embodiment of this invention, in catalyst supporting using the capillary action, it becomes possible to cause a larger amount of catalyst to adhere onto the honeycomb substrate 10 while suppressing adhesion of the catalyst to the outer peripheral coating layer 13.

### <Joined Body>

The honeycomb structure 1 according to an embodiment of this invention may form a joined body in which the honeycomb substrate 10 includes a plurality of honeycomb substrates 10, the plurality of honeycomb substrates 10 are joined by a joining layer for joining the plurality of honeycomb substrates 10 to each other, and the outer peripheral coating layer 13 is provided so as to surround outer peripheral surfaces of the plurality of honeycomb substrates 10 joined by the joining layer. The number of honeycomb substrates 10 making up the joined body is not particularly limited, and it can typically be about 9 to 16.

The joining layer is formed by applying a paste-like joining material onto outer peripheral surfaces of the plurality of honeycomb substrates 10, and drying and curing it. As the joining material used for forming the joining layer, it is preferable that the joining material is composed of a material containing a filler consisting of heat-resistant ceramic fibers, ceramic particles, and the like, and an inorganic adhesive such as colloidal silica as main components.

By the joined body being formed by joining the plurality of honeycomb substrates 10 to each other through the joining layer, thermal stress is relieved by the joining layer, so that generation of cracks in the honeycomb substrates 10 can be suppressed even when sudden temperature changes in an exhaust gas or local heat generation occurs. Further, in the joined body, the outer peripheral coating layer 13 is formed after joining the plurality of honeycomb substrates 10 through the joining layer and cutting and processing an outer peripheral portion to desired dimensions, so that improvement in dimensional accuracy of the joined body can also be achieved.

### <Filter>

A honeycomb filter can be produced using the honeycomb structure 1 according to an embodiment of this invention. The honeycomb filter includes: a pillar shaped honeycomb substrate 10 having porous partition walls 12 that define a plurality of cells 11, each of the cells 11 extending from an inflow end face 14 to an outflow end face 15 of the honeycomb substrate 10 to form a flow path for a fluid; and a porous outer peripheral coating layer 13 disposed on an outer peripheral surface of the honeycomb substrate 10, wherein the honeycomb substrate 10 includes pores having a pore diameter that causes capillary action in the partition walls 12, a catalyst is supported on the partition walls 12, and when an average pore diameter of the honeycomb substrate 10 is B [μm] and an average pore diameter of the outer peripheral coating layer is A [μm], a relationship of B<A is satisfied.

In the plurality of cells 11 defined by the porous partition walls 12, plugging may be formed so as to form a complementary checkered pattern at the inflow end face 14 and the outflow end face 15. By forming such plugging in the cells 11, when a fluid flows through a diesel particulate filter (DPF) that uses the honeycomb filter according to the present embodiment, the fluid does not pass through as it is from the inflow end face 14 to the outflow end face 15, but passes through the partition walls 12 on which the catalyst is supported at least once. By passing the fluid through the partition walls 12 on which the catalyst is supported, particulate matters contained in the fluid can be removed.

### <Catalyst>

In the honeycomb structure 1 and the honeycomb filter according to an embodiment of this invention, the catalyst is supported on the partition walls 12 by catalyst supporting using capillary action. The catalyst is not particularly limited as long as it can burn particulate matters by heat of the exhaust gas. Such catalysts can be, for example, single substances or compounds containing elements selected from precious metal elements, elements from Group VIa of the periodic table, and elements from Group VIII of the periodic table. More specifically, single substances or compounds containing elements such as platinum (Pt), palladium (Pd), rhodium (Rh), nickel (Ni), cobalt (Co), molybdenum (Mo), tungsten (WN), cerium (Ce), copper (Cu), vanadium (V), iron (Fe), gold (Au), silver (Ag) and the like can be used as a catalyst. As the catalyst, a NOx selective reduction catalyst component or a NOx storage-reduction catalyst component may be used.

An amount of the catalyst supported on the partition walls 12 of the honeycomb substrate 10 by catalyst supporting using the capillary action varies depending on a catalyst to be used, an average pore diameter and an average porosity of the honeycomb substrate 10, and the like, and is preferably 10 to 200 g/L, and more preferably 50 to 150 g/L, although not particularly limited thereto. It should be noted that the amount of the catalyst supported can be calculated, for example, by cutting out a block of a specific volume of the honeycomb substrate 10 at a central portion in the extending direction of the cells 11 of the honeycomb structure 1 after catalyst supporting, and dividing a mass difference before and after supporting the catalyst by the cut-out volume.

In catalyst supporting using the capillary action, the inflow end face 14 and the outflow end face 15 of the honeycomb structure 1 are immersed in a catalyst solution containing the catalyst for a certain period of time, and the capillary action causes the catalyst solution to penetrate from the inflow end face 14 or the outflow end face 15 toward the extending direction of the cells 11. Therefore, the concentration of the honeycomb structure 1 in the catalyst solution immersed in the catalyst solution tends to be highest at the inflow end face 14 or the outflow end face 15 and to gradually decrease from the inflow end face 14 to the outflow end face 15 or from the outflow end face 15 to the inflow end face 14. Therefore, for the honeycomb filter obtained by heating the honeycomb structure 1, the catalyst is supported so that the amount of the catalyst is progressively reduced from the inflow end face 14 to the outflow end face 15 or from outflow end face 15 to inflow end face 14. The state of the catalyst supported on the honeycomb structure 1 can be evaluated by observing a sample cut along the extending direction of the 11 cells of the honeycomb structure 1 using a scanning electron microscope (SEM).

### <Production Method>

A method for producing the honeycomb structure 1 according to an embodiment of this invention includes: (a) a step S1 of producing a honeycomb substrate 10; (b) a step S2 of cutting and processing an outer peripheral surface of the honeycomb substrate 10; (c) a step S3 of forming an outer peripheral coating layer 13 on the outer peripheral surface of the honeycomb substrate 10 to produce the honeycomb structure 1; and (d) a step S4 of supporting a catalyst on the honeycomb structure 1 using capillary action. In the following examples, a case where cordierite is used as a ceramic raw material for producing the honeycomb structure 1 will be described.

In the step S1, a raw material composition containing a ceramic raw material, a dispersion medium, a pore former, and a binder is kneaded to prepare a green body, and then the green body is extruded and dried to produce the honeycomb substrate 10. Additives such as a dispersant can be blended in the raw material composition as necessary. For the extrusion, a die having a desired overall shape, cell shape, partition wall thickness, cell density and the like can be used.

Examples of the ceramic raw materials include raw materials for obtaining ceramics, such as cordierite, mullite, zirconium phosphate, aluminum titanate, silicon carbide, silicon-silicon carbide composite materials (e.g., Si-bonded SiC), cordierite-silicon carbide composite materials, zirconia, spinel, indialite, sapphirine, corundum, titania, and silicon nitride. Specifically, examples include, but not limited to, silicon carbide, silicon, silica, talc, alumina, kaolin, serpentine, pyrophyllite, brucite, boehmite, mullite, magnesite, and aluminum hydroxide. Silicon oxide, strontium oxide, and aluminum oxide, which are added as sintering aids, are also types of ceramic raw materials. The ceramic raw material may be used alone, or in combination with two or more kinds.

Examples of the dispersion medium include water or a mixed solvent of water and an organic solvent such as alcohol, and more preferably water. The content of the dispersant is can 25 to 45 parts by mass with respect to 100 parts by mass of ceramic powder.

The pore former is not particularly limited as long as it forms pores after firing, and examples include wheat flour, starch, foamed resin, water-absorbing resin, silica gel, carbon (e.g., graphite, cokes), ceramic balloon, polyethylene, polystyrene, polypropylene, nylon, polyester, acrylic, and phenol. The pore former may be used alone, or in combination with two or more kinds. From a viewpoint of forming the pore diameter that causes capillary action in the honeycomb substrate 10 and adjusting the honeycomb substrate 10 to the porosity suitable for catalyst supporting using capillary action, the content of the pore former is preferably 1.0 to 30.0 parts by mass, more preferably 3 to 27 parts by mass, and still more preferably 5 to 24 parts by mass with respect to 100 parts by mass of the ceramic raw material.

Examples of the binder include organic binder such as methyl cellulose, hydroxypropyl cellulose, hydroxyethyl cellulose, carboxymethyl cellulose, and polyvinyl alcohol. In particular, it is preferable to use methyl cellulose in combination with hydroxypropyl cellulose. The content of the binder is preferably 3 to 10 parts by mass or less, more preferably 4 to 9 parts by mass or less, and even more preferably 5 to 8 parts by mass or less, with respect to 100 parts by mass of the ceramic raw material. The binder may be used alone, or in combination with two or more kinds. Further, examples of the dispersant include ethylene glycol, dextrin, fatty acid soaps, polyether polyol, and the like. The content of the dispersant is preferably 0 to 3 parts by mass or less, more preferably 0.1 to 2.5 parts by mass, and even more preferably 0.2 to 2.0 parts by mass or less, with respect to 100 parts by mass of the ceramic raw material.

When plugging the inflow end face 14 and the outflow end face 15 of a honeycomb formed body, its method is not particularly limited, and a well-known method such as filling cell openings of the inflow end face and the outflow end face on which a predetermined mask is attached with a plugging slurry can be adopted. A material of the plugged portions is not particularly limited, but it may preferably be ceramics from viewpoints of strength and heat resistance. Examples of the ceramics include those containing one or more of cordierite, mullite, zirconium phosphate, aluminum titanate, silicon carbide, silicon-silicon carbide composite materials (e.g., Si-bonded Sic), cordierite-silicon carbide composite materials, zirconia, spinel, indialite, sapphirine, corundum, titania, and silicon nitride. The plugged portions are preferably formed of a material containing these ceramics in a total of 50% by mass or more, and more preferably formed of a material containing 80% by mass or more. It is even more preferable that the plugged portions have the same material composition as the formed body, because an expansion rate during firing can be made the same, leading to improved durability.

The method for producing the honeycomb formed body is also not particularly limited, and in addition to the above extruding, injection molding, press molding, and the like can be used. As a method for drying the obtained formed body, any method such as hot air drying, microwave drying, dielectric drying, reduced pressure drying, vacuum drying, freeze drying, and the like can be used. After drying the formed body, the formed body is held in a firing furnace heated at 1300 to 1600° C., preferably 1350 to 1430° C., in an atmospheric pressure atmosphere for 3 to 105 hours to obtain the honeycomb substrate 10.

In the step S2, an outer peripheral surface of the honeycomb substrate 10 is ground to predetermined dimensions and shape. The grinding can be performed by a known method. It should be noted that, when desired dimensions and shape are obtained after forming in the step S1 and grinding is not necessary, the step S2 may be omitted without grinding an outermost periphery of the honeycomb substrate 10. When joining the plurality of honeycomb substrates 10 to each other, a joining material may be applied to outer peripheral walls of the honeycomb substrates 10 and heated at about 200° C. or less to join the plurality of honeycomb substrates 10 to each other via the joining layer. As the joining material, for example, one prepared by mixing anisotropic inorganic powder, aggregate, amorphous particles containing Si, and a dispersion medium such as water can be used.

As a material of the anisotropic inorganic powder, a natural mineral may be used, or artificial ceramic fibers may be used. Examples of suitable natural mineral include needle-like or plate-like natural minerals such as wollastonite, mica, talc, sepiolite, palygorskite, and attapulgite. Further, examples of suitable artificial ceramic fibers include ceramic fibers such as RCF (amorphous refractory ceramic fiber containing alumina and silica as main components), alumina fiber, mullite fiber, carbon fiber, silicon carbide fiber, boron nitride fiber, potassium titanate fiber, and zinc oxide fiber. The anisotropic inorganic powder may be used alone, or in combination with two or more types.

Examples of the material of the aggregate include ceramics, such as cordierite, mullite, zirconium phosphate, aluminum titanate, silicon carbide, silicon-silicon carbide composite materials (e.g., Si-bonded SiC), cordierite-silicon carbide composite materials, zirconia, spinel, indialite, sapphirine, corundum, titania, and silicon nitride.

Any inorganic or organic binder may be used as a binder. Examples of the organic binder include organic binders such as methylcellulose, hydroxypropyl methylcellulose, carboxymethylcellulose, and polyvinyl alcohol. Examples of the inorganic binder includes clay minerals such as bentonite, montmorillonite, sepiolite, and attapulgite. The binder may be used alone or in combination of two or more types.

A dispersant such as polyethylene glycol oleate may be further added to the joining slurry. Examples of the pore former include organic substances such as hollow or solid organic balloons including foamed resin, water-absorbent resin, and starch, and inorganic substances such as fly ash balloons. The pore former may be used alone, or in combination with two or more types.

In the step S3, after an outer peripheral coating material is applied so as to surround an outer peripheral surface of the honeycomb substrate 10, it is dried and heated to form the outer peripheral coating layer 13 on the outer peripheral surface of the honeycomb substrate 10, thereby producing the honeycomb structure 1.

Examples of the outer peripheral coating material include a material obtained by adding additives such as an organic binder, a pore former, and a dispersant, and water to inorganic raw materials such as inorganic fibers, colloidal silica, clay, and ceramic particles, and kneading the mixture into a slurry. A method for applying the outer peripheral coating material is not particularly limited, and a known method can be used. It should be noted that it is preferable to use grinding dust obtained during grinding of the outer peripheral surface of the honeycomb substrate 10 in the step S2 as the outer peripheral coating material, because raw materials used for producing the honeycomb structure 1 can be effectively utilized.

As the ceramic raw material powder for the outer peripheral coating layer 13, cordierite particles having an average particle diameter D50 of, for example, 1 to 1000 μm, preferably 2 to 800 μm, and more preferably 3 to 600 μm, can be used in order to form the outer peripheral coating layer 13 having pores having an average pore diameter A [μm] larger than an average pore diameter B [μm] of the honeycomb substrate 10 and having an average porosity P1 [%]. When SiC powder and metallic Si powder are used as the ceramic raw material powder, for example, the average particle diameter D50 of the SiC powder is preferably 5 to 50 μm, more preferably 7 to 40 μm, and even more preferably 9 to 30 μm. The average particle diameter D50 of the Si powder is preferably 2 to 12 μm, more preferably 3 to 10 μm, and even more preferably 4 to 8 μm. It should be noted that the average particle diameter D50 refers to a particle diameter corresponding to a cumulative frequency of 50% in a volume-based particle size distribution measured by a laser diffraction/scattering method.

A material for a green body (additive) is added to the ceramic raw material powder to prepare an outer peripheral coating material. As the additive, at least a binder and a pore former are used. Other than the binder and the pore former, a dispersant or a surfactant can be used. As the binder and the pore former, the same ones as the material of the honeycomb substrate 10 can be used. As the pore former, a particle diameter or fiber diameter (average diameter) thereof is preferably 5 to 300 μm, and more preferably 10 to 200 μm. Further, as the pore former, it is preferable to use a material such that the average pore diameter A of the outer peripheral coating layer 13 is larger than the average pore diameter B of the honeycomb substrate 10, or a pore former having a larger particle diameter than the pore former used in the honeycomb substrate 10. Furthermore, in order to make the average pore diameter A of the outer peripheral coating layer 13 larger than the average pore diameter B of the honeycomb substrate 10, in addition to increasing a particle diameter of the pore former, a particle diameter of a main raw material serving as aggregate may be increased.

As a method for forming the outer peripheral coating layer 13, for example, a method can be used in which the honeycomb substrate 10 is placed on a rotating table and rotated, and an outer peripheral coating material is discharged from a blade-shaped coating nozzle while pressing the coating nozzle so as to follow an outer peripheral portion of the honeycomb substrate 10 to apply it. By using such a method, the outer peripheral coating layer 13 can be applied with a uniform thickness. In addition, surface roughness of the formed outer peripheral coating layer 13 becomes small, so that the outer peripheral coating layer 13 having excellent appearance and being difficult to be damaged by thermal shock can be formed. A method for drying the outer peripheral coating material is not particularly limited. For example, from a viewpoint of preventing drying cracks, a method can be used in which 25% or more of moisture in the outer peripheral coating material is dried by holding it at room temperature for 24 hours or more, and then moisture and organic substances are removed by holding it at 600° C. for 1 hour or more in an electric furnace. It should be noted that, when plugging is performed on the cells 11 after forming the honeycomb structure 1, the plugging may be performed by pushing a paste-like material with a spatula such as a squeegee after forming the outer peripheral coating layer 13.

In the step S4, a catalyst liquid containing a catalyst to be supported on the honeycomb structure 1 is prepared, and the honeycomb structure 1 is immersed in the catalyst liquid to support the catalyst using capillary action.

As a method for supporting the catalyst, a known dip-coating method in which the honeycomb structure 1 is immersed in a catalyst solution may be used, but in this case, the amount of the catalyst supported in the outer peripheral coating layer 13 increases. In one embodiment, the honeycomb structure 1 is stood perpendicular to the surface of the catalyst solution and held for a predetermined time while one end face (e.g., the inflow end face 14) of the honeycomb structure 1 is immersed. By this holding, the catalyst solution is sucked up into pores of the partition walls 12 of the honeycomb substrate 10 by capillary force, thereby filling the pores with the catalyst. The honeycomb structure 1 is then inverted, and the honeycomb structure 1 is stood perpendicular to the surface of the catalyst solution and held for a predetermined time while the other end face (e.g., the outflow end face 15) is immersed. By this holding, the catalyst solution is sucked up into the pores of the partition walls 12 of the honeycomb substrate 10 by capillary force, thereby filling the pores with the catalyst. The suction of the catalyst solution from the end face using capillary force can be repeated a plurality of times. In another embodiment, the catalyst may be supported by a method such as a suction method in which one end face (e.g., the inflow end face 14) of the honeycomb structure 1 is immersed in the catalyst solution and the catalyst solution is sucked from the other end face.

According to the method for producing the honeycomb structure 1 according to the embodiment of this invention, a honeycomb structure 1 is used in which a honeycomb substrate 10 has pores in partition walls 12 having a pore diameter that causes capillary action, and an average pore diameter B of the honeycomb substrate 10 is smaller than an average pore diameter A of an outer peripheral coating layer 13. During catalyst supporting, the catalyst solution penetrates more into the pores of the partition walls 12 of the honeycomb substrate 10 than into the outer peripheral coating layer 13 due to capillary action; therefore, it is possible to cause the catalyst to adhere selectively onto the honeycomb substrate 10 while preventing the catalyst from adhering to the outer peripheral coating layer 13.

### EXAMPLES

Hereinafter, Examples and Comparative Examples according to this invention will be described, but the technical scope of this invention is not intended to be limited by these Examples.

### Examples 1 to 12

As ceramic raw material powder, silicon carbide (SiC) powder and silicon (Si) powder were mixed at a mass ratio of 80:20, to which a pore former (starch), an organic binder (hydroxypropyl methylcellulose), a surfactant (oleate ester), and water were added in appropriate amounts to obtain a green body. Using this green body, a rectangular parallelepiped honeycomb formed body was produced by extruding. The pillar shaped honeycomb formed body was degreased at about 450° C. in an air atmosphere, and further fired at about 1450° C. in an Ar atmosphere to obtain a rectangular parallelepiped honeycomb substrate having the following specifications.
Bottom shape: 35 mm square on each side;
Total length: 150 mm;
Average porosity: as listed in Table 1;
Average pore diameter: as listed in Table 1;
Average thickness of partition walls: 0.3 mm;
Cell cross-sectional shape: square;
Cell density: 46 cells/cm²; and
Average thickness of outer peripheral side wall: 0.5 mm.

A joining material was produced by mixing anisotropic inorganic powder (mullite fiber), aggregate (silicon carbide, cordierite), pore former (foamed resin), binder (carboxymethyl cellulose), and dispersant (PEG monophosphate ester) in a mixer. This joining slurry was applied to sides of the honeycomb substrate obtained by the above procedure to a thickness of approximately 1 mm, and a step of placing another honeycomb substrate obtained by the above procedure thereon was repeated to produce a segment laminate composed of a total of 16 honeycomb substrates combined in 4 rows×4 columns. Then, after joining the whole by applying a pressure from the outside as appropriate, it was dried at 120° C. for 2 hours to obtain a joined body.

After grinding the periphery of the joined body so that its outer shape became cylindrical, an outer peripheral coating layer 13 having a thickness of 1.5 mm was formed on the processed surface, which was the outer peripheral surface of the honeycomb substrate. The outer peripheral coating layer was formed by adding a pore former so as to have an average pore diameter larger than that of the honeycomb substrate, and applying an outer peripheral coating material obtained at a ratio of grinding dust (SiC and metallic Si): 60, colloidal silica: 20, and alumina: 20, by pressing an application nozzle along an outer peripheral portion of the honeycomb substrate. This outer peripheral coating material was dried and fired at 600° C. for 2 hours to produce honeycomb structures 1 according to Examples 1 to 12 having average pore diameters and average porosities shown in Table 1. A catalyst was supported on each of the honeycomb structures 1 according to Examples 1 to 12. Table 1 shows measurement results of various physical properties of the honeycomb substrates 10 and the outer peripheral coating layers 13 of the honeycomb structures 1 according to Examples 1 to 12.

### Comparative Examples 1 to 2

As ceramic raw material powders, SiC powder and Si powder were mixed at a mass ratio of SiC powder:Si powder=80:20, and the same pore former, organic binder, surfactant, and water as in Examples 1 to 12 were added thereto to obtain a plastic green body. Using this green body, a rectangular parallelepiped honeycomb formed body was produced by extruding. The honeycomb formed body was degreased at about 450° C. in an air atmosphere and fired at about 1450° C. in an Ar atmosphere to obtain a rectangular parallelepiped honeycomb substrate having the following specifications.
Bottom shape: 35 mm square on each side;
Total length: 150 mm;
Average porosity: as listed in Table 1;
Average pore diameter: as listed in Table 1;
Average thickness of partition walls: 0.3 mm;
Cell cross-sectional shape: square;
Cell density: 46 cells/cm²;
Average thickness of outer peripheral side wall: 0.5 mm.

After grinding the periphery of the joined body so that its outer shape became cylindrical, an outer peripheral coating layer 13 having a thickness of 1.5 mm and having the average pore diameter and the average porosity shown in Table 1 was formed on the processed surface, which was the outer peripheral surface of the honeycomb substrate 10. The outer peripheral coating material was dried and fired at 600° C. for 2 hours to produce the honeycomb structures according to Comparative Examples 1 and 2. For the honeycomb structures according to Comparative Examples 1 and 2, a catalyst was supported on each of the honeycomb structures in the same method as that of Examples 1 to 12. Table 1 shows measurement results of various physical properties of the honeycomb substrates and the outer peripheral coating layers of the honeycomb structures according to Comparative Examples 1 to 2.

One end face of each of the honeycomb structures according to Examples 1 to 12 and Comparative Examples 1 and 2 was immersed in a catalyst solution to support the catalyst by capillary action, and then the other end face was immersed in the catalyst solution to support the catalyst by capillary action. In the evaluation of catalyst applicability, a case where a target amount of catalyst could be supported on the honeycomb substrate and the amount of catalyst supported on the outer peripheral coating layer was smaller than that on the honeycomb substrate was evaluated as “circle”; a case where the amount of catalyst supported on the outer peripheral coating layer was smaller than that on the honeycomb substrate but seepage of the catalyst from the outer peripheral coating layer occurred was evaluated as “triangle”; and a case where the amount of catalyst supported on the outer peripheral coating layer was larger than that on the honeycomb substrate and the target amount of catalyst could not be applied onto the honeycomb substrate was evaluated as “x”.

TABLE 1

| | Average pore diameter (μm) | | Average porosity (%) | | | |
|---|---|---|---|---|---|---|
| | Honeycomb | Outer peripheral | Honeycomb | Outer peripheral | | |
| | substrate | coating layer | substrate | coating layer | Catalyst applicability | |
| Ex. 1 | 18 | 20 | 65 | 60 | ∘ | — |
| Ex. 2 | 13 | 280 | 52 | 40 | ∘ | — |
| Ex. 3 | 13 | 160 | 52 | 34 | ∘ | — |
| Ex. 4 | 12 | 30 | 48 | 43 | ∘ | — |
| Ex. 5 | 9 | 60 | 48 | 34 | ∘ | — |
| Ex. 6 | 5 | 6.5 | 30 | 30 | ∘ | — |
| Ex. 7 | 13 | 20 | 42 | 60 | ∘ | — |
| Ex. 8 | 24 | 40 | 68 | 55 | ∘ | — |
| Ex. 9 | 9 | 300 | 48 | 42 | ∘ | |
| Ex. 10 | 18 | 115 | 65 | 60 | Δ | Catalyst seepage |
| Ex. 11 | 18 | 435 | 65 | 40 | Δ | Catalyst seepage |
| Ex. 12 | 9 | 50 | 48 | 70 | Δ | Catalyst seepage |
| Comp. 1 | 18 | 14 | 65 | 30 | x | Reduced catalyst supporting on substrate |
| Comp. 2 | 9 | 7 | 48 | 43 | x | Reduced catalyst supporting on substrate |

### DESCRIPTION OF REFERENCE NUMERALS

1: honeycomb structure
10: honeycomb substrate
11: cell
12: partition wall
13: outer peripheral coating layer
14: inflow end face
15: outflow end face

1. A honeycomb structure comprising:
a pillar shaped honeycomb substrate having porous partition walls that define a plurality of cells, each of the cells extending from an inflow end face to an outflow end face of the honeycomb substrate to form a flow path for a fluid; and
a porous outer peripheral coating layer disposed on an outer peripheral surface of the honeycomb substrate,
wherein the honeycomb substrate comprises pores having a pore diameter that causes capillary action in the partition walls, and wherein, when an average pore diameter of the honeycomb substrate is B [μm], and an average pore diameter of the outer peripheral coating layer is A [μm], a relationship of B<A is satisfied.

2. The honeycomb structure of claim 1, wherein when an average porosity of the honeycomb substrate is P2 [%] and an average porosity of the wherein outer peripheral coating layer is P1 [%], a relationship of A>B×(P1/P2)^{0.2} is satisfied.

3. The honeycomb structure of claim 1, wherein when an average porosity of the outer peripheral coating layer is P1 [%], a relationship of A<670−⅙×P1² is satisfied.

4. The honeycomb structure of claim 1, wherein the average pore diameter B of the honeycomb substrate is 5 μm to 30 μm.

5. The honeycomb structure of claim 1, wherein the average pore diameter A of the outer peripheral coating layer is more than 5 μm and 500 μm or less.

6. The honeycomb structure of claim 1, wherein the average porosity P2 of the honeycomb substrate is 20 to 70%.

7. The honeycomb structure of claim 1, wherein the average porosity P1 of the outer peripheral coating layer is 30 to 75%.

8. The honeycomb structure of claim 1, wherein the average pore diameter B is 5 μm to 30 μm, an amount of catalyst supported on the partition walls of the honeycomb substrate is larger than an amount of catalyst supported on the outer peripheral coating layer, and the honeycomb structure is configured to support a catalyst on the honeycomb substrate and the outer peripheral coating layer by capillary force.

9. The honeycomb structure of claim 1, wherein the average pore diameter B is 5 μm to 30 μm and wherein when an average porosity of the honeycomb substrate is P2 [%] and an average porosity of the wherein outer peripheral coating layer is P1 [%], a relationship of A>B×(P1/P2)^{0.2} is satisfied.

10. The honeycomb structure of claim 9, wherein when an average porosity of the outer peripheral coating layer is P1 [%], a relationship of A<670−⅙×P1² is satisfied.

11. The honeycomb structure of claim 1, wherein the average pore diameter B of the honeycomb substrate is 5 μm to 13 μm.

12. The honeycomb structure of claim 1, wherein the honeycomb substrate comprises a plurality of honeycomb substrates,
the plurality of honeycomb substrates are joined by a joining layer for joining the plurality of honeycomb substrates to each other, and
the outer peripheral coating layer is provided so as to surround outer peripheral surfaces of the plurality of honeycomb substrates joined by the joining layer.

13. A honeycomb filter comprising:
a pillar shaped honeycomb substrate having porous partition walls that define a plurality of cells, each of the cells extending from an inflow end face to an outflow end face of the honeycomb substrate to form a flow path for a fluid; and
a porous outer peripheral coating layer disposed on an outer peripheral surface of the honeycomb substrate,
wherein the honeycomb substrate comprises pores having a pore diameter that causes capillary action in the partition walls, a catalyst is supported on the partition walls, and when an average pore diameter of the honeycomb substrate is B [μm] and an average pore diameter of the outer peripheral coating layer is A [μm], a relationship of B<A is satisfied.

14. The honeycomb filter of claim 13, wherein the average pore diameter B is 5 μm to 30 μm, and an amount of catalyst supported on the partition walls of the honeycomb substrate is larger than an amount of catalyst supported on the outer peripheral coating layer.

15. The honeycomb filter of claim 13, wherein the amount of the catalyst supported is progressively reduced from the inflow end face to the outflow end face, or from the outflow end face to the inflow end face.
